(19) United States
(12) Patent Application Publication
(10) Pub. No.: US 2025/0073584 A1
(43) Pub. Date: Mar. 6, 2025

(54) METHOD FOR LOCATION BASED PLAYER FEEDBACK TO IMPROVE GAMES

(71) Applicant: Sony Interactive Entertainment Inc., Tokyo (JP)

(72) Inventors: Chen Yao, Bloomingdale, IL (US); Jun Murakawa, Foster City, CA (US); Nobuyuki Nakamura, Yokohoma (JP); Sagnik Chowdhury, San Jose, CA (US); Ratnakar Pawar, San Mateo, CA (US); Robert Brown, San Mateo, CA (US)

(21) Appl. No.: 18/208,179

(22) Filed: Jun. 9, 2023

(51) Int. Cl. A63F 13/533; A63F 13/5375; A63F 13/67; A63F 13/798

(52) U.S. Cl. CPC A63F 13/533; A63F 13/5375; A63F 13/67; A63F 13/798

(57) ABSTRACT

A system for location-based player feedback for video games may include a data collection module, a pattern recognition module, a localization module and a feedback module. The collection module collects gameplay data for a video game. The pattern recognition module analyzes the collected gameplay data to identify a pattern associated with player difficulty. The localization module associates a game world location with the identified pattern. The feedback module presents a message to players at the game world location associated with the identified pattern requesting feedback. The data collection, pattern recognition, and localization modules may include neural networks trained with machine learning algorithms.

### FIELD OF THE DISCLOSURE

This disclosure relates to video games, and more particularly to location-based player feedback for video games.

### BACKGROUND OF THE DISCLOSURE

It is currently difficult for video game publishers to dynamically adjust games at scale based on real-time signals from players after initial publishing. Game testing prior to launch provides limited feedback on how players actually interact with the game. Interactions of large numbers of players with the game after release are a potentially vast yet untapped source of feedback.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which: FIG. 1 is a schematic diagram of a location-based player feedback system for video games according to an aspect of the present disclosure.

FIG. 2 is a flow diagram of a method for location-based player feedback for video games according to an aspect of the present disclosure.

FIG. 3 is a diagram showing an example of a multi-modal data collection architecture for a location-based player feedback system according to an aspect of the present disclosure.

FIG. 4 depicts an example of a game screen of a video game that implements a location-based player feedback system for video games according to an aspect of the present disclosure.

FIG. 5A shows another example game screen of a video game that implements a location-based player feedback system for video games according to an aspect of the present disclosure.

FIG. 5B shows an example of context information associated with the game screen of FIG. 5A.

FIG. 5C shows an example of a game screen depicting an example of player assistance in the form of a “ghost” player character.

FIG. 6 is a flow diagram of a method for training a neural-network to implement a method for location-based player feedback for video games according to an aspect of the present disclosure.

FIG. 7A is a simplified node diagram of a recurrent neural network that may be used in location-based player feedback according to aspects of the present disclosure.

FIG. 7B is a simplified node diagram of an unfolded recurrent neural network that may be used in location-based player feedback according to aspects of the present disclosure.

FIG. 7C is a simplified diagram of a convolutional neural network that may be used in location-based player feedback according to aspects of the present disclosure.

FIG. 7D is a block diagram of a method for training a neural network that may be used in location-based player feedback according to aspects of the present disclosure.

FIG. 8 is a block diagram of a system implementing a location-based player feedback system for video games according to an aspect of the present disclosure.

FIG. 9 is a block diagram of a computer-readable medium encoded with instructions that, upon execution implement a method for location-based player feedback for video games according to an aspect of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

The block diagram shown in FIG. 1 depicts a non-limiting example of an implementation of a location-based player feedback system 100, according to some aspects of the present disclosure. In implementation depicted, the system 100 includes a data collection module 110 configured to collect gameplay data for a video game, a pattern recognition module 120 configured to analyze the collected gameplay data to identify a pattern associated with player difficulty with the video game, a localization module 130 configured to associate a game world location with the identified pattern, and a feedback module 140 configured to present a message to players at the game world location associated with the identified pattern requesting feedback.

Components of the system 100 may be configured to communicate with other devices over a Network 150, e.g., through a suitably configured network interface. For example, the data collection module 110 may retrieve gameplay data over the network 150 from a remote gameplay data database 160. The gameplay data database 160 may, in turn, collect gameplay date from an arbitrary number N of client devices 170₁, 170₂, 170₃ . . . 170_{N}, which may be gaming consoles, portable gaming devices, desktop computers, laptop computers or mobile devices, such as tablet computers or cell phones that are configured to allow players to play the game. The gameplay database 160 may additionally receive gameplay data from a game server 180 that is configured to perform computations and other functions that allow the players to play the game via the client devices 170₁, 170₂, 170₃ . . . 170_{N}.

In some implementations, the pattern recognition module 120 may include a first neural network 122 that is trained to detect patterns in gameplay data that may be associated with player difficulty with video games. The first neural network 122 may be trained with a suitably configured machine learning algorithm 124. In some implementations, the localization module 130 may include a second neural network 122 that is trained to identify game world locations from the patterns of gameplay data detected by the first neural network 122. The second neural network 132 may be trained with a suitably configured machine learning algorithm 134. By way of non-limiting example, the second neural network 132 may be trained to identify game world locations from patterns of gameplay data identified by the second neural network 122.

In some implementations, the messaging module 140 may include one or more trained networks 142 trained with one or more suitably configured machine learning algorithms 144. By way of example, these may include a neural network trained to classify a difficulty with the video game from the identified pattern. In some implementations, the neural networks 142 may include a neural network trained to classify a difficulty with the video game from the identified game world location. In some implementations, the neural networks 142 may include a neural network trained to classify a difficulty with the video game from the identified pattern and identified game world location.

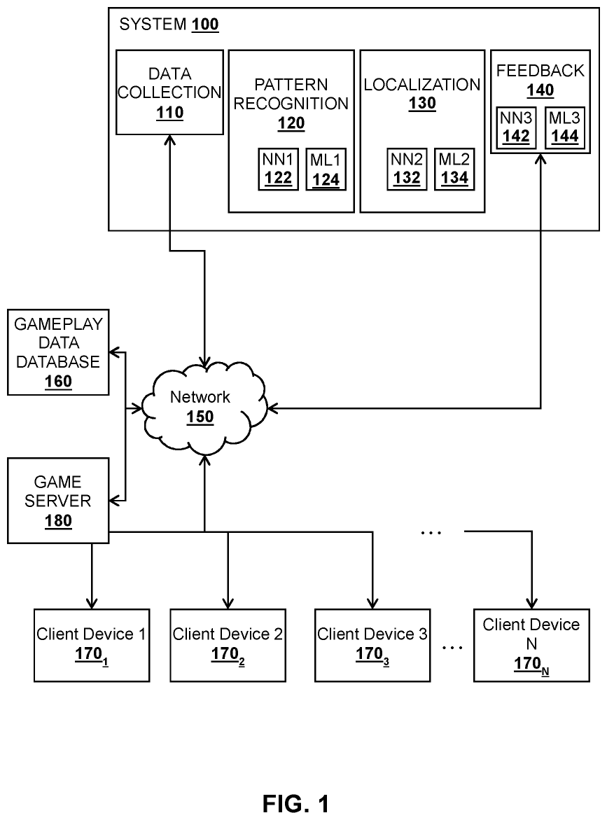

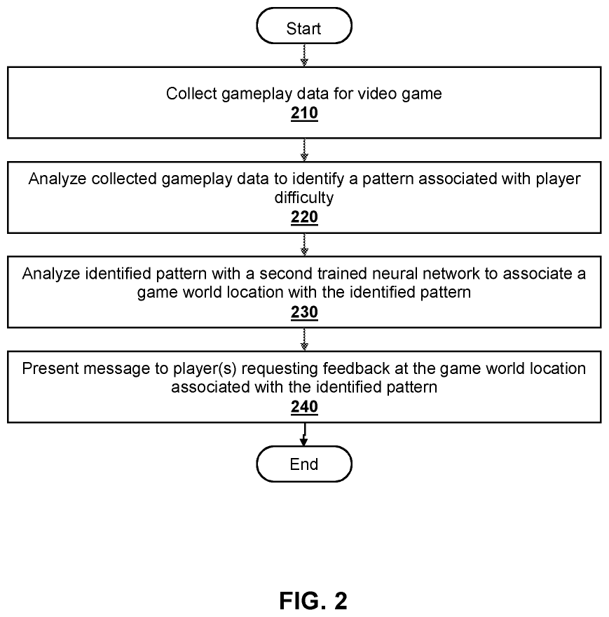

FIG. 2 is a flow diagram that describes a location-based player feedback method, according to some aspects of the present disclosure. In some implementations, the method may include collecting gameplay data for a video game, as indicated at 210. There are a number of types of gameplay data that may be collected. The nature of collection depends partly on the source of the data. Some data, such as controller inputs, may be collected directly from a player's gaming console or portable gaming device. In online gaming implementations, some data may be collected from the game server 180 that implements certain computations based on a player's controller inputs and transmits video data back to the player's device. Still other data may be collected from a data service associated with the game server. Other data may be collected from social media services that are associated with the game server or with the player. The collection module 110 may collect gameplay data over some predetermined window of time. The window of time may be long enough to collect enough data to be useful to the pattern recognition module 120. In some implementations, structured gameplay data that may be relevant to difficulty with a game world location may be provided by a game engine running on one or more of the client devices 170₁, 170₂, 170₃ . . . 170_{N} or on the game server 180. Such structured data may include, e.g., the game title, current game level, current game task, time spent on current task or current level, number of previous attempts at current task by the player, current game world locations for player and non-player characters, game objects in a player character's inventory, player ranking, and the like.

There are a number of different types of data that may be collected. Some non-limiting examples include current game level, current game activity, player character load out (e.g., weapons or equipment), player rank, time spent on a game session, time spent in a particular region or level of a game world, and number of times a player has failed at a particular task, just to name a few.

In some implementations, the data collection module 110 may collect video game telemetry data. Game telemetry data can provide insight in to what activity player is doing, what equipment or weapons a player character can access, the player's game world location, the amount of time within a game world region, or how many times players failed an activity, among other things. As used herein, video game telemetry data refers to the information collected by games through various sensors, trackers, and other tools to monitor player behavior, game performance, and other relevant metrics. Some examples of video game telemetry data include (1) player activity, such as data on how long players spend on specific levels or missions, the frequency of their logins, the amount of time spent in the game, and how often they return to the game, (2) in-game actions performed by players, such as the number of kills or deaths in a first-person shooter game, or the number of goals scored in a soccer game, (3) game performance including data on how the game performs, such as the frame rate, latency, and other technical metrics that can impact the player experience, (4) player engagement, such as the number of times they use specific features or interact with certain game elements, (5) error reports generated by the game or experienced by players, (6) platform information, such as device type, and operating system, (7) user demographic information, such as age, gender, location, and other relevant data, (8) social features, such as how player interact each other with in-game chat and friend invites, (9) in-game economy, such as tracking patterns of purchases and/or sales of virtual items, and (10) progression, such as tracking player achievements and/or trophies and/or pace of progress.

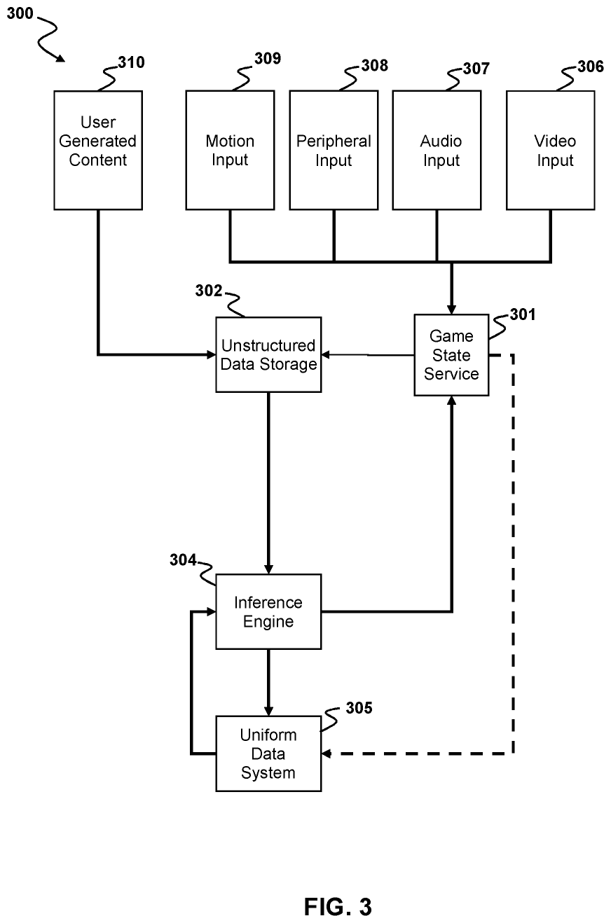

In some implementations, the collection module 110 in the system 100 may collect unstructured gameplay data, such as video image data, game audio data, controller input data, group chat data, and the like. It may be useful to provide structure to such data to facilitate processing by the pattern recognition module 120, localization module 130, and feedback module 140. Furthermore, the collection module 110 may collect different modes of data, such as video data, audio data, along with structured data. FIG. 3 is a diagram showing an example of data collection system architecture 300 for a location-based player feedback system that can collect multi-modal gameplay data. In the implementation shown the system 300 may execute an application that does not expose the application data structure to a uniform data system 305, which may include the gameplay database 160. Instead, the inputs to the application such as peripheral input 308 and motion input 309 are interrogated by a game state service 301 and sent to unstructured data storage 302. The game state service 301 also interrogates unstructured application outputs such as video data 306 and audio data 307 and stores the data with unstructured data storage 302. Additionally, user generated content (UGC) 310 may be used as inputs and provided to the unstructured data storage 302. The game state service 301 may collect raw video data from the application which has not entered the rendering pipeline of the device. Additionally, the game state service 301 may also have access to stages of the rendering pipeline and as such may be able to pull game buffer or frame buffer data from different rendered layers which may allow for additional data filtering. Similarly raw audio data may be intercepted before it is converted to an analog signal for an output device or filtered by the device audio system.

The inference engine 304 receives unstructured data from the unstructured data storage 302 and predicts context information from the unstructured data. The context information predicted by the inference engine 304 may be formatted in the data model of the uniform data system. The inference engine 304 may also provide context data for the game state service 301 which may use the context data to pre-categorize data from the inputs based on the predicted context data. In some implementations, the game state service 301 may provide game context updates at update points or at game context update interval to the data system 305. These game context updates may be provided by the data system 305 to the inference engine 304 and used as base data points that are updated by context data generated by the inference engine. The context information may then be provided to the uniform data system 305. The UDS 305 may also provide structured information to the inference engine 304 to aid in the generation of context data.

In some implementations, it may be desirable to reduce the dimensionality of the gameplay data collected by the collection module 110. Data dimensionality may be reduced through the use of feature vectors. As used herein, a feature vector refers to a mathematical representation of a set of features or attributes that describe a data point. It can be used to reduce the dimensionality of data by converting a set of complex, high-dimensional data into a smaller, more manageable set of features that capture the most important information.

To create a feature vector, a set of features or attributes that describe a data point are selected and quantified. These features may include numerical values, categorical labels, or binary indicators. Once the features have been quantified, they may be combined into a vector or matrix, where each row represents a single data point and each column represents a specific feature.

The dimensionality of the feature vector can be reduced by selecting a subset of the most relevant features and discarding the rest. This can be done using a variety of techniques, including principal component analysis (PCA), linear discriminant analysis (LDA), or feature selection algorithms. PCA, for example, is a technique that identifies the most important features in a dataset and projects the data onto a lower-dimensional space. This is done by finding the directions in which the data varies the most, and then projecting the data onto those directions. The resulting feature vector has fewer dimensions than the original data, but still captures the most important information. As an example, consider a dataset corresponding to images of different objects, where each image is represented by a matrix of pixel values. Each pixel value in the matrix represents the intensity of the color at that location in the image. Treating each pixel value as a separate feature results in a very high-dimensional dataset, which can make it difficult for machine learning algorithms to classify or cluster the images. To reduce the dimensionality of the data, the system 100, e.g., data collection module 110 and/or pattern recognition module 120, may create feature vectors that summarizes the most important information in each image, e.g., by calculating the average intensity of the pixels in the image, or extracting features that capture the edges or shapes of the objects in the image. Once a feature vector is created for each image, these vectors can be used to represent the images in a lower-dimensional space, e.g., by using principal component analysis (PCA) or another dimensionality reduction technique to project the feature vectors onto a smaller number of dimensions.

Referring again to FIG. 2, at 220, the collected gameplay data may then be analyzed, e.g., with the first trained neural network 122, to identify a pattern in the gameplay data that is associated with player difficulty with the video game. There are a number of different gameplay data patterns that the first neural network may be trained to detect. By way of non-limiting examples, first neural network may be trained to detect (1) repeated unsuccessful attempts to complete a game level, repeated unsuccessful attempts to complete a game tasks within a game level, (3) erratic, aberrant or unusual patterns of controller input indicative of frustration, e.g., multiple repeated button presses after failure to complete a task, inertial sensor input consistent with the player throwing the controller, (4) player speech, e.g., detected with a microphone on a game console, gaming headset, or controller, that is indicative of frustration, (5) text or voice chat language indicative of frustration, (6) player facial expression or body language indicative of frustration, e.g., determined from analysis of images of the player obtained with a video camera trained on the player, (7) user generated content (UGC) expressing frustration with a game, and (8) patterns of player input and game output likely to cause frustration. As an example of pattern (8), consider a situation in which the movement of a game character that the player controls is inconsistent with the player's controller inputs.

In some implementations, the first trained neural network NN1 in the pattern recognition module 120 may be trained to detect patterns in game telemetry data that may suggest player frustration, either on their own or in combination with other patterns. Examples of such patterns may include (1) patterns of players spending an inordinate time on specific levels or missions, changes in the frequency of their logins or the amount of time spent in the game, (2) patterns of inactivity during a game session, (3) patterns in game performance including frame rate or latency, (4) patterns of player engagement, such use of specific game features or interaction with certain game elements, (5) patterns in error reports generated by the game or reported by players, (6) patterns in platform information, such as device type, and operating system, and (7) user demographic information, such as age, gender, location, and other relevant data.

It is further noted that the pattern recognition module 120 may be configured to detect combinations of two or more types of patterns. Detecting multiple patterns may improve the likelihood of detecting actual player frustration and decrease the likelihood of false positives.

Once a pattern is recognized, the pattern recognition module may provide the localization module 130 with a set of relevant gameplay data and/or game telemetry data corresponding to the detected pattern or patterns. Such relevant gameplay data may include structured data, such as game title, game level, game world location (if provided by the game engine), transcripts of relevant player speech, chat, or UGC, game screen images or video, game audio, controller inputs, relevant game telemetry data. The relevant data may correspond to a subset of the gameplay data collected by the collection module 110 and/or data corresponding to inferences drawn by the first neural network 122 from analysis of that data. Such inferences may include structured data derived from unstructured data. The relevant data may relate to what the player is doing and where the player has been within the game world during the window of time over which the collection module 110 has collected gameplay data. The relevant data may also include metadata that, e.g., identifies the nature of a pattern, e.g., “too many failures” at this level, “high latency”, “erratic controller input”, and the like.

At 230, the method may include analyzing the identified pattern with a second trained neural network to associate a game world location with the identified pattern. By way of example, and not by way of limitation, the second neural network 132 may analyze the relevant data provided by the pattern recognition module 120 to determine whether or not the pattern has any relation to a particular game world location. This may be done by determining, e.g., if the pattern repeatedly appears while the player's character is in a particular game world location or if the player's session ends while the player is in a particular game world location. For example, in a loot-based game, a pattern of a player character repeatedly falling into the same trap could be associated with the location of the trap. As another example, in a racing game, a pattern of a player character repeatedly crashing on the same curve on a given racetrack could be associated with the location of the curve on the racetrack. A further example may be a pattern of players taking too long to solve particular puzzle in an adventure game, making repeated attempts, or quitting in the game in the area could be associated with the location of the puzzle in the game world. An additional example may be a pattern of many players losing in combat against a specific enemy or boss character and a change in player engagement could be associated with the location of the challenging enemy encounter in the game world.

Once a pattern or patterns have been identified and associated with a game world location, the method may include presenting a message requesting feedback to one or more players at the game world location associated with the identified pattern, as indicated at 240. There are a number of different ways in which the message may be presented.

According to aspects of the present disclosure, a game feedback module 140 may surface a feedback card for particular assets associated with a specific location in the game world. The feedback card is configured to provide feedback to a publisher from game players. For example, a neural network could analyze gameplay data to determine locations where players tend to exit part of a game, either by failing a task, or voluntarily giving up. Alternatively, the neural network could analyze text or audio communications between players on player messaging system. In the case of text communications, a first neural network could decompose the communications to determine their contexts and then a second neural network could analyze the contexts to determine which of the messages are relevant to difficulty with the game. In some implementations, a third neural network may analyze the relevant messages to determine the nature of the difficulty.

Once a difficult location is identified, the game could surface a message at that particular location asking players if the game is too hard at this location. Such messages can provide considerable information on what players do in the game world, what they enjoy, what they find challenging and what they find frustrating. The answers may be fed as inputs into the first neural network. In some implementations, the feedback module 140 may include a trained neural network that compares a player's answers to the player's actions to estimate the relevance or usefulness of the feedback. For example, a player's feedback that a particular location in a game is too difficult might not be relevant or useful if the player never visited the location during actual gameplay.

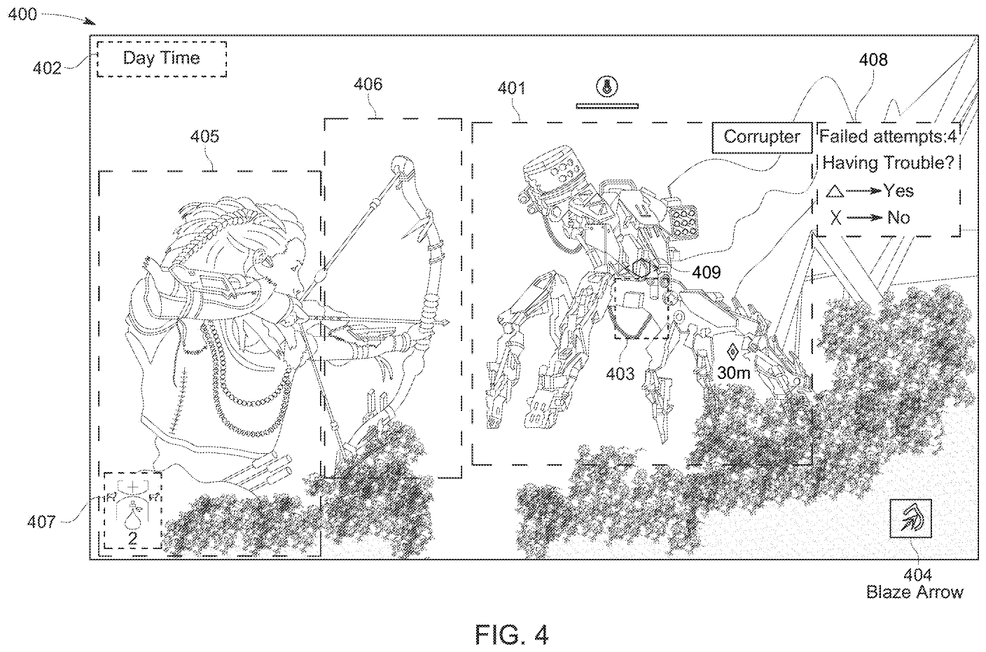

FIG. 4 depicts an example of a decomposed game screen 400 showing presentation of a message requesting feedback according to aspects of the present disclosure. The game screen holds a large amount of context information that may be collected by the collection module, predicted and formatted into contextual information, e.g., by the inference engine 304 of FIG. 3 that is analyzed by the pattern recognition module 120 and/or localization module 130. For example, the inference engine may be trained with a machine learning algorithm to identify that the screen is showing; the user 405, with a bow 406, fighting an enemy 401, in the daytime 402. The inference engine may identify generic context information as discussed and in some implementations the inference engine may be further trained to identify specialized context information based on, for example and without limitation, the game title. The inference engine with specialized training may predict further context information for the scene based on the game title so the decomposed game screen 400 may be predicted as Aloy 405, protagonist of the Horizon games, wielding a Carja Hunter bow 406, aimed at the weak point 403 of a corruptor type enemy 401 in the daytime 402. Additionally, the inference engine may be trained to identify various contextual elements of the user interface such as shown here, an ammo type is active and ammo count 404, and that there is an item in the active inventory 407. Specialized training of the inference engine may allow the inference engine to provide further context to the decomposed screen, for example that the active ammo type is blaze arrows and the health potions are in the active inventory slot.

In this example, the player has failed in four attempts to defeat this particular enemy with the particular type of bow and arrow shown. The pattern recognition module 120 may determine that the number of repeated failed attempts is a sign of difficulty. The pattern recognition module may also have determined a number of possible causes of the difficulty. For example, the player may be aiming in the wrong spot, there may be a latency between the controller input that triggers release of the arrow from the bow, or the arrows are not having the intended effect. Furthermore, the localization module 130 may determine that the player has not had difficulty defeating this type of enemy with the chosen bow and arrow in other locations within the game world. The feedback module may display a message 408 on the screen asking if the player is having trouble and prompting the player to press the controller's “triangle” button for “yes” and the “cross” key for “no”. The feedback module 140 may reply to a “yes” input from the player in a number of different ways, such as a request for additional information or an offer of help. The request for additional information may include suggestions of possible difficulties, such as “Not hitting weak point?”, “Hitting weak point without effect?”, “Not hitting where aiming?”, “Arrow release is delayed?” The feedback module may include a trained neural network that takes the player's response into account when recommending help. For example, the player indicates that they are not hitting the weak point 403 or not hitting where aiming, the feedback module may suggest that the play adjust their point of aim 409. If the player indicates that they are hitting the weak point without effect, the feedback module may determine that this is a technical issue and may notify the game developer. If the player indicates latency between controller input and arrow release, the feedback module may determine that there is a network latency issue and may adjust the game accordingly, e.g., by slowing down the reactions of the enemy 401. Alternatively, the system may compensate for latency by skipping mechanics or character attack animation in order to shorten the time it takes for an attack to reach the enemy.

There are a number of other ways in which the feedback module 140 may present a message and/or receive feedback. For example, the feedback module or player could surface an interactive element, referred to herein as a “glitch card” that attaches a stream of metadata showing the glitch. The attached metadata may include, for example, current quest, mechanics, enemy and glitch type, e.g., graphics, controller and so on. The glitch card may provide additional data or metadata to the player as well. In some implementations, to generate the metadata, the interactive element may be configured to allow the player to turn on a “watch me” feature when having trouble. The feedback module 140 could direct the collection module 110 to collect telemetry data while the “watch me feature” is turned on and then direct the pattern recognition module 120 to analyze the collected data to determine the nature of the difficulty, e.g., whether it is a technical issue with the game, a network issue, or has something to do with how the player plays the game. In some implementations, the system 300 may watch the player in the background and analyze a history of events to determine when to escalate an issue to a developer. The feedback module 140 could access historical information, e.g., from the UDS 305 and could determine whether an issue should be escalated to developer.

The feedback module 140 may be configured to ask the player to elaborate on difficulties with games. There are a number of different types of feedback that developers may want to receive. The following are some non-limiting examples.

Some developers may want to know when to “nerf” a weapon used by a player or non-player character if it is too effective. In the context of video games, to “nerf” a weapon means to decrease its power or effectiveness. This could involve reducing its damage output, increasing its reload time, or making it less accurate, among other changes.

In some implementations, the feedback module 140 may allow players to request tunables in certain game world locations. In the context of video games, “tunables” are settings or parameters that can be adjusted by the game developer to change the behavior or performance of the game without requiring a patch or update to be downloaded by players. Tunables are typically stored on a game server and can be adjusted remotely by the game developer. This allows them to make quick changes to the game's balance, difficulty, or other parameters in response to feedback from players or to address issues that are discovered after the game's release. Examples of tunables include the drop rate of rare items in a loot-based game, the speed at which characters move or attack in a fighting game, or the amount of damage that different weapons or abilities do in a shooter. As another example, tuning the enemy spawn rate and respawn time of resources may affect player progression and game experiences. Further examples of tunables may include adjustments to the in-game economy system. These may include adjustments to in-game currency acquisition, item pricing, and cost of upgrades and other similar economic factors that affect player engagement in long term. Additionally, a game's environment and physics parameters may be tunable. For example, adjustments to gravity, character movement speed, jump height, or friction can refine the feel and responsiveness of the control during game play. In some implementations, the feedback module could surface a “Game Balance Card” that allows a player to request tunables at any location within the game world. In some such implementations, the feedback module 140 may generate a heat map of locations where players are requesting tunables and provide that to the game developer.

In other implementations, the feedback module 140 could surface a help card, e.g., if it detects player is having trouble. There are a number of different ways such a help card might be configured and/or surfaced. For example, in some implementations, the note card may be an explicit message asking whether the play needs help, as in the example illustrated in FIG. 4. Alternatively, the help card may be implemented as part of the game's sticky notes. In the context of the present application, “sticky notes” refers to a type of in-game collectible or objective. Such sticky notes may appear in the game world as small, brightly colored pieces of paper or virtual notes that are scattered throughout the game world and can be collected by the player. Such sticky notes may contain clues, hints, or messages that help the player progress through the game or unlock additional content, such as new levels, characters, or items. In some implementations, sticky notes may allow a player to activate help features of the types described herein, such as the “watch me” feature or game balance card feature to provide other useful information to the game developer via the feedback module 140.

In some implementations, the feedback module 140 may respond to requests for help by asking players if they want to see a successful path through a difficult part of the game. Such a successful path may be displayed as a “ghost” player character that is semi-transparent and that the player can follow while playing the game.

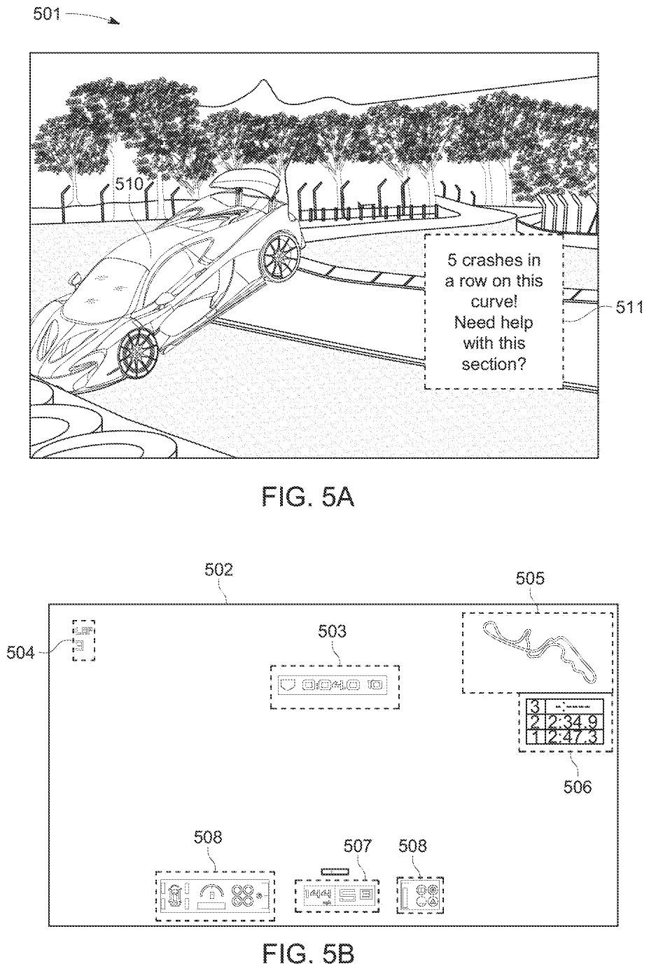

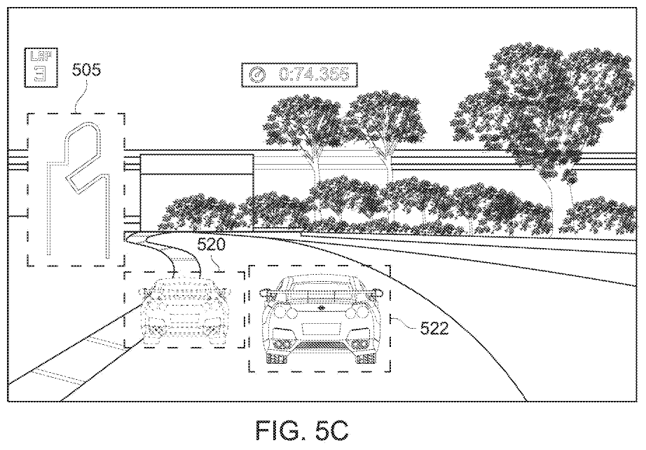

FIGS. 5A-5C illustrate an example of the use of a “ghost” player character in the context of a racing game. FIG. 5A, shows an example of a game screen image 501 in which a player character's race car 510 has crashed while attempting to round a certain curve on a race track. In this example, the pattern recognition module 120 has detected that this is the fifth crash in a row during this session for this particular player and the localization module 130 has determined that all five crashes have taken place on this particular curve. The feedback module 140 has presented a message 511 asking if the player needs help. For simplicity, FIG. 5A omits certain user interface elements, however, if present, the pattern recognition module and localization module may be configured extract context from the unstructured information they provide.

To illustrate how the pattern recognition module and localization module might work with unstructured data, FIG. 5B illustrates extracted user interface elements according to aspects of the present disclosure. By way of example, the inference engine may receive user interface (UI) rendering layer images from the game state service. The UI often includes densely packed information for the user of the application and as such processing power and processing time may be saved by decomposing the UI rendering layer to generate context information. The inference engine here may predict contextual information within the UI layer. For example and without limitation, in the racing UI shown the inference engine may identify the context information of lap time 503, lap number 504, track name and track position 505, race ranking and relative time ranking 506, current speed and drive gear number 507, and Fuel level and active vehicle features 508. The inference engine 304 may place this information in the data model of the UDS 302, for access by the pattern recognition module 120, localization module 130 and feedback module 140. Thus, with only data available on the rendering layer a large amount of contextual information may be predicted, this saves processing power and time because modules of the inference engine that operate on images/video do not need to operate on the entire image.

By way of example, the pattern recognition module may determine that the difficulty is the result of, e.g., the player's speed and position when entering a curve and the localization module may associate this difficulty with the particular curve. Furthermore, the feedback module 140 may use this information in a number of different ways to suggest help ranging from a simple message, such as “enter this curve close to the left side” up to an offer to show a ghost race car 520 handling the curve, as depicted in FIG. 5C. The feedback module 140 may generate the ghost racer in a number of different ways. For example, the feedback module may use one or more of the trained neural networks 142 to analyze user generated content 310 to find video examples of other players navigating the same curve. A selected example may be alpha-blended onto the screen along with the player's race car 522 as the player plays. If the feedback module 140 has access to sufficiently detailed gameplay data, it may synthetically generate the ghost race car 520 as a non-playable character, calculate the necessary controller inputs to navigate the ghost race car around the curve and provide these to the game server player's client device or the game server 180.

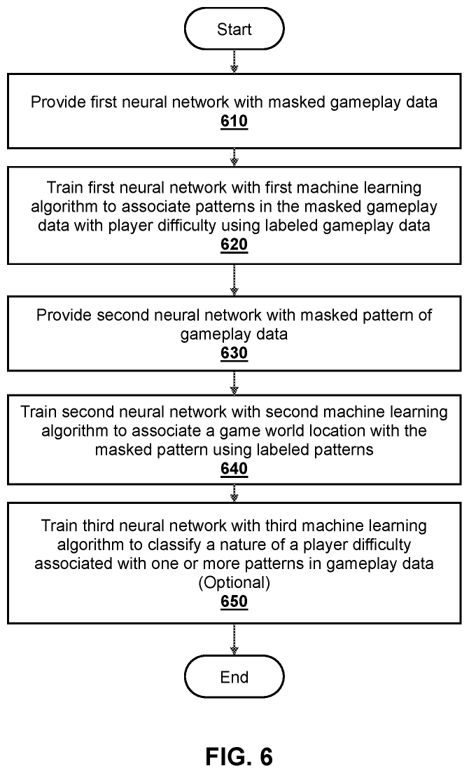

According to aspects of the present disclosure, the pattern recognition module 120, localization module 130 and feedback module 140 may include trained neural networks. Aspects of the present disclosure include methods of training such neural networks. By way of example, and not by way of limitation, FIG. 6 depicts a flowchart that illustrates a method for training location-based player feedback system for video games, according to some aspects of the present disclosure. In some implementations, at 610, the method may include providing masked gameplay data for a video game to a first neural network, such as neural network 122 in the pattern recognition module 120. In some implementations, the masked gameplay data may include one or more modes of multimodal gameplay data. In some implementations, the masked gameplay data may be provided in the form of one or more feature vectors to reduce the dimensionality of the data while retaining the relevant information. As indicated at 620, the first neural network may be trained with a first machine learning, e.g., algorithm 124, to associate one or more patterns in the masked gameplay data with player difficulty with the video game using labeled gameplay data, which may include one or more modes of multimodal data or may include one or more feature vectors. At 630, the method may include providing a second neural network, such as neural network 132 of the localization module 130 with a masked pattern of gameplay data for a video game. In some implementations, the masked gameplay data may be provided in the form of one or more feature vectors to reduce the dimensionality of the data while retaining the relevant information. The second neural network is then trained with a second machine learning algorithm, e.g., algorithm 134, to associate a game world location with the masked pattern of gameplay data using labeled patterns of gameplay data, as indicated at 640. In some implementations, the method 600 may optionally include training a third neural network 142 with a third machine learning algorithm 144 to classify a nature of a player difficulty associated with one or more patterns in gameplay data, as indicated at 650. In such implementations, training the third neural network may include providing the third neural network with a masked pattern of gameplay data for a video game associated with player difficulty and training the third neural network 142 with the third machine learning algorithm 144 to classify a nature of a player difficulty corresponding to the masked pattern of gameplay data using labeled patterns of gameplay data.

Although the aspects of the disclosure are not so limited, many of the implementations discussed above utilize trained neural networks trained by corresponding machine learning algorithms. Aspects of the present disclosure include methods of training such neural networks with such machine learning algorithms. By way of example, and not limitation, there are a number of ways that the machine learning algorithms 124, 134 may train the corresponding neural networks 122, 132. Some of these are discussed in the following section.

### Generalized Neural Network Training

The NNs discussed above may include one or more of several different types of neural networks and may have many different layers. By way of example and not by way of limitation the neural network may consist of one or multiple convolutional neural networks (CNN), recurrent neural networks (RNN) and/or dynamic neural networks (DNN). The Motion Decision Neural Network may be trained using the general training method disclosed herein.

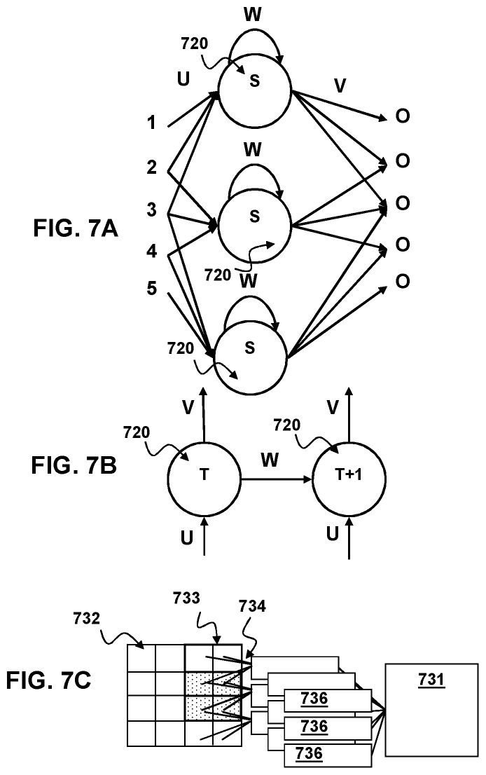

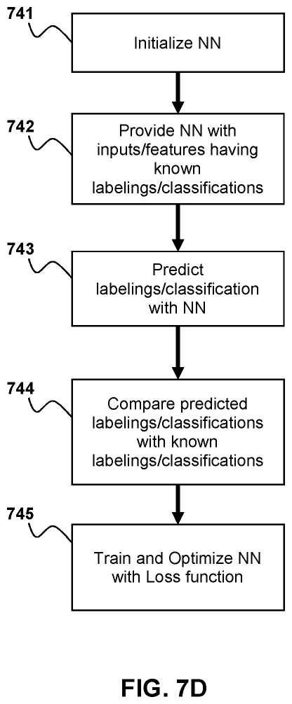

By way of example, and not limitation, FIG. 7A depicts the basic form of an RNN that may be used, e.g., in the trained model. In the illustrated example, the RNN has a layer of nodes 720, each of which is characterized by an activation function S, one input weight U, a recurrent hidden node transition weight W, and an output transition weight V. The activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 7B, the RNN may be considered as a series of nodes 720 having the same activation function moving through time T and T+1.

Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 7C depicts an example layout of a convolution neural network such as a CRNN, which may be used, e.g., in a trained model according to aspects of the present disclosure. In this depiction, the convolution neural network is generated for an input 732 with a size of 4 units in height and 4 units in width giving a total area of 16 units. The depicted convolutional neural network has a filter 733 size of 2 units in height and 2 units in width with a skip value of 1 and a channel 736 of size 9. For clarity in FIG. 7C only the connections 734 between the first column of channels and their filter windows is depicted. Aspects of the present disclosure, however, are not limited to such implementations. According to aspects of the present disclosure, the convolutional neural network may have any number of additional neural network node layers 731 and may include such layer types as additional convolutional layers, fully connected layers, pooling layers, max pooling layers, local contrast normalization layers, etc. of any size.

As seen in FIG. 7D Training a neural network (NN) begins with initialization of the weights of the NN, as indicated at 741. In general, the initial weights should be distributed randomly. For example, a NN with a tanh activation function should have random values distributed between

$$- \frac{1}{\sqrt{n}} and \frac{1}{\sqrt{n}}$$

where n is the number of inputs to the node.

After initialization, the activation function and optimizer are defined. The NN is then provided with a feature vector or input dataset at 742. Each of the different feature vectors that are generated with a unimodal NN may be provided with inputs that have known labels. Similarly, the multimodal NN may be provided with feature vectors that correspond to inputs having known labeling or classification. The NN then predicts a label or classification for the feature or input at 743. The predicted label or class is compared to the known label or class (also known as ground truth) and a loss function measures the total error between the predictions and ground truth over all the training samples at 744. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc., as indicated at 745. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNs that do not include Recurrent or hidden layers.

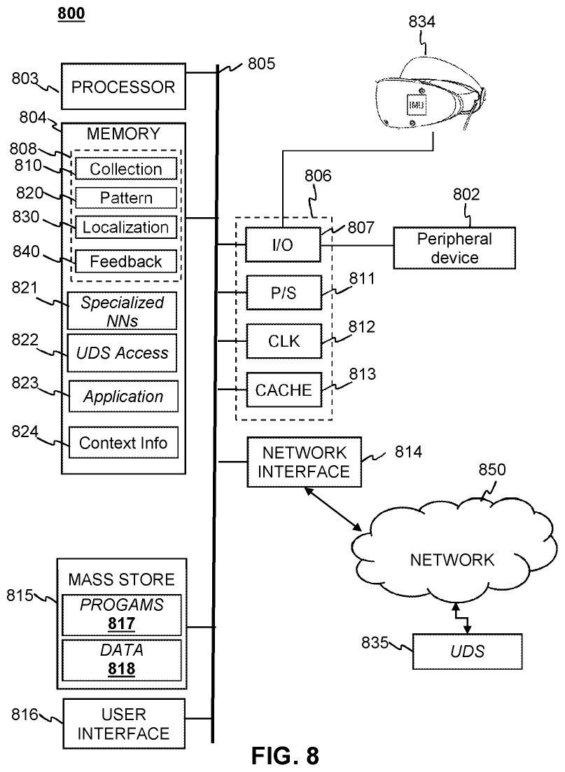

FIG. 8 depicts a system according to aspects of the present disclosure. The system may include a computing device 800 coupled to a user peripheral device 802 and a HUD 834. The peripheral device 802 may be a controller, display, touch screen, microphone or other device that allows the user to input speech data in to the system. The HUD 834 may be a Virtual Reality (VR) headset, Altered Reality (AR) headset or similar. The HUD may include one or more IMUs which may provide motion information to the system. Additionally, the peripheral device 802 may also include one or more IMUs.

The computing device 800 may include one or more processor units and/or one or more graphical processing units (GPU) 803, which may be configured according to well-known architectures, such as, e.g., single-core, dual-core, quad-core, multi-core, processor-coprocessor, cell processor, and the like. The computing device may also include one or more memory units 804 (e.g., random access memory (RAM), dynamic random-access memory (DRAM), read-only memory (ROM), and the like). The computing device may optionally include a mass storage device 815 such as a disk drive, CD-ROM drive, tape drive, flash memory, or the like, and the mass storage device may store programs and/or data.

The processor unit 803 may execute one or more programs, portions of which may be stored in memory 804 and the processor 803 may be operatively coupled to the memory, e.g., by accessing the memory via a data bus 805. The programs may be configured to implement a location based feedback system 808, which may include a collection module 810, pattern detection module 820, localization module 830 and feedback module 840. These modules may be configured, e.g., as discussed above. The memory 804 may also contain software modules such as a UDS system access module 821 and specialized NN Modules 822. By way of example, the specialized neural network modules may implement components of the inference engine 304. The Memory 804 may also include one or more applications 823, such as game applications, context information 824 generated by the location based feedback system 808 and/or the specialized neural network modules 822. The overall structure and probabilities of the NNs may also be stored as data 818 in the Mass Store 815 as well as some or all of the data available to the UDS 835. The processor unit 803 is further configured to execute one or more programs 817 stored in the mass store 815 or in memory 804 which cause the processor to carry out a method for training a NN from feature vectors 810 and/or input data. The system may generate Neural Networks as part of the NN training process. These Neural Networks may be stored in the memory 804 as part of the location based feedback system 808, or Specialized NN Modules 821. Trained NNs and their respective machine learning algorithms may be stored in memory 804 or as data 818 in the mass store 815.

The computing device 800 may also include well-known support circuits, such as input/output (I/O) 807, circuits, power supplies (P/S) 811, a clock (CLK) 812, and cache 813, which may communicate with other components of the system, e.g., via the bus 805. The computing device may include a network interface 814 to facilitate communication with other devices. The processor 803 and network interface 814 may be configured to implement a local area network (LAN) or personal area network (PAN), via a suitable network protocol, e.g., Bluetooth, for a PAN. The computing device 800 may also include a user interface 816 to facilitate interaction between the system and a user. The user interface may include a keyboard, mouse, light pen, game control pad, touch interface, game controller, or other input device.

The network interface 814 to facilitate communication via an electronic communications network 850. For example, part of the UDS 835 may be implemented on a remove server that can be access via the network 850. The network interface 814 may be configured to facilitate wired or wireless communication over local area networks and wide area networks such as the Internet. The device 800 may send and receive data and/or requests for files via one or more message packets over the network 1620. Message packets sent over the network 850 may temporarily be stored in a buffer in the memory 804.

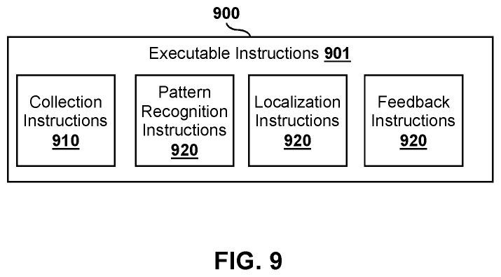

Aspects of the present disclosure include physical and tangible embodiments of computer executable instructions configured to implement aspects of the methods described herein upon execution. By way of non-limiting example, FIG. 9 is a block diagram that describes executable instructions 900 embodied in a non-transitory computer-readable medium, according to some aspects of the present disclosure. The executable instructions 900 may also include one or more instructions 910 configured to collect gameplay data for a video game, when executed, e.g., as discussed above with respect to collection module 110. The executable instructions 900 may also include one or more instructions 920 configured to analyze the collected gameplay data with a first trained neural network to identify a pattern associated with player difficulty with the video game, when executed, e.g., as discussed above with respect to pattern recognition module 120.

In some implementations, the executable instructions 900 may also include one or more instructions 930 configured to analyze the identified pattern with a second trained neural network to associate a game world location associated with the identified pattern, when executed, e.g., as discussed above with respect to localization module 130. The executable instructions 900 may also include one or more instructions 940 configured to present a message requesting feedback to one or more players at the game world location associated with the identified pattern, when executed, e.g., as described above with respect to feedback module 140.

Aspects of the present disclosure may leverage artificial intelligence to provide timely, localized and useful feedback to game developers and also provide effective and timely assistance to video game players. Timely and localized feedback can help developers rapidly improve games after they have been launched. Effective and timely assistance may enhance player's gaming experience and improve player retention.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A system for location-based player feedback for video games
a data collection module configured to collect gameplay data for a video game;
a pattern recognition module configured to analyze the collected gameplay data to identify a pattern associated with player difficulty with the video game;
a localization module configured to associate a game world location with the identified pattern;
a feedback module configured to present a message to players at the game world location associated with the identified pattern requesting feedback.

2. The system of claim 1 wherein the pattern recognition module includes a neural network trained to detect patterns in gameplay data that are associated with player difficulty with video games.

3. The system of claim 1 wherein the localization module includes a neural network configured to identify game world locations from patterns of gameplay data.

4. The system of claim 1 wherein the feedback module includes a neural network trained to classify a difficulty with the video game from the identified pattern.

5. The system of claim 1 wherein the feedback module includes a neural network trained to classify a difficulty with the video game from the identified game world location.

6. The system of claim 1 wherein the feedback module includes a neural network trained to classify a difficulty with the video game from the identified pattern and identified game world location.

7. The system of claim 1, wherein the data collection module is configured to collect the gameplay data over a network from a plurality of video game devices.

8. A method for location-based player feedback for video games, comprising:
collecting gameplay data for a video game;
analyzing the collected gameplay data with a first trained neural network to identify a pattern associated with player difficulty with the video game;
analyzing the identified pattern with a second trained neural network to associate a game world location with the identified pattern; and
presenting a message requesting feedback to one or more players at the game world location associated with the identified pattern.

9. The method of claim 8, wherein the collected gameplay data includes data relating to location of one or more player characters in the game world.

10. The method of claim 8, wherein the collected gameplay data includes data relating to a game level for the video game.

11. The method of claim 8, wherein the collected gameplay data includes time a player has spent in a particular region of the game world.

12. The method of claim 8, wherein the collected gameplay data includes an amount of time a player has failed to complete a game level of the video game.

13. The method of claim 8, wherein the collected gameplay data includes an amount of time a player has failed to complete a game task of the video game.

14. The method of claim 8, wherein the collected gameplay data relates to a game activity occurring in a game level of the video game.

15. The method of claim 8, wherein the collected gameplay data relates to an amount of time spent by a player on a game activity in the video game.

16. The method of claim 8, wherein the collected gameplay data includes equipment associated with one or more player characters.

17. The method of claim 8, wherein the collected gameplay data includes a player rank of one or more players.

18. The method of claim 8, wherein the collected gameplay data includes data corresponding to one or more controller inputs.

19. The method of claim 8, wherein analyzing the gameplay data includes generating a heat map of game world locations where players have requested an ability to tune one or more parameters of one or more features of the game world.

20. The method of claim 8, wherein the one or more features of the game world include one or more objects, non-player characters, or terrain features.

21. The method of claim 8, wherein analyzing the identified pattern includes determining one or more game world locations where players have exited a part of a game.

22. The method of claim 8, wherein analyzing the identified pattern includes determining one or more game world locations where players have exited a part of a game as a result of failing a task.

23. The method of claim 8, wherein analyzing the identified pattern includes determining one or more game world locations where players have exited a part of a game by voluntarily giving up.

24. The method of claim 8, further comprising analyzing player feedback in response to the message to classify the player difficulty with game.

25. The method of claim 24, wherein analyzing feedback in response to the message includes comparing a player's feedback to the player's actions to estimate a relevance or usefulness of the feedback.

26. The method of claim 8, further comprising responding to player feedback.

27. The method of claim 26, wherein responding to the player feedback includes escalating the player feedback to a developer of the video game.

28. The method of claim 8, wherein the message asks whether the game is too difficult at the game world location associated with the identified pattern.

29. The method of claim 8, wherein the message requesting feedback includes an offer of help with the video game at the game world location associated with the identified pattern.

30. The method of claim 29, wherein the offer of help includes an offer to guide a player through a difficult part of the video game.

31. The method of claim 29, wherein the offer of help includes an offer to show a player video of a successful attempt by another player to complete a task at the game world location associated with the identified pattern.

32. The method of claim 8, wherein presenting the message includes classifying a difficulty with the video game from the identified pattern and/or identified game world location.

33. The method of claim 8, further comprising receiving feedback from one or more players in response to the message.

34. The method of claim 33, wherein the feedback includes recording detailed gameplay data as player plays the video game.

35. The method of claim 33, wherein the feedback includes recording detailed gameplay data as player plays the video game at the game world location associated with the identified pattern.

36. The method of claim 33, wherein the feedback includes recording detailed gameplay data as player plays the video game at the game world location associated with the identified pattern and sending the recorded data to a publisher of the video game.

37. The method of claim 33, wherein the feedback includes a stream of metadata showing a problem with the video game at the game world location associated with the identified pattern.

38. A method for training a location-based player feedback system for video games, comprising:
providing a first neural network with masked gameplay data for a video game;
training the first neural network with a first machine learning algorithm to associate one or more patterns in the masked gameplay data with player difficulty with the video game using labeled gameplay data;
providing second neural network with a masked pattern of gameplay data for a video game;
training the second neural network with a second machine learning algorithm to associate a game world location with the masked pattern of gameplay data using labeled patterns of gameplay data.

39. The method of claim 38, wherein the masked gameplay data provided to the first neural network includes one or more modes of multimodal data.

40. The method of claim 39, wherein the labeled gameplay data includes one or more modes of multimodal data.

41. The method of claim 38, wherein the masked gameplay data provided to the first neural network includes one or more feature vectors.

42. The method of claim 41, wherein the labeled gameplay data includes one or more feature vectors.

43. The method of claim 38, further comprising training a third neural network to classify a nature of a player difficulty associated with one or more patterns in gameplay data.

44. The method of claim 39 wherein training the third neural network includes providing the third neural network with a masked pattern of gameplay data for a video game associated with player difficulty; and
training the third neural network with a third machine learning algorithm to classify a nature of a player difficulty corresponding to the masked pattern of gameplay data using labeled patterns of gameplay data.

45. A non-transitory computer-readable medium having executable instructions embodied therein, comprising:
one or more collection instructions configured to collect gameplay data for a video game, when executed;
one or more pattern recognition instructions configured to analyze the collected gameplay data with a first trained neural network to identify a pattern associated with player difficulty with the video game, when executed;
one or more localization instructions configured to analyze the identified pattern with a second trained neural network to associate a game world location associated with the identified pattern, when executed; and
one or more instructions messaging configured to present a message requesting feedback to one or more players at the game world location associated with the identified pattern, when executed.
